(19) United States
(12) Patent Application Publication
(10) Pub. No.: US 2023/0234557 A1
(43) Pub. Date: Jul. 27, 2023

(54) METHOD FOR OPERATING A HYBRID DRIVE TRAIN

(71) Applicant: DEUTZ Aktiengesellschaft, Koeln (DE)

(72) Inventors: Manuel HIRMER, Koeln (DE); Taghi AKBARIAN, Koeln (DE)

(21) Appl. No.: 18/096,924

(22) Filed: Jan. 13, 2023

(30) Foreign Application Priority Data
Jan. 22, 2022 (DE) 102022000227.2

(51) Int. Cl. B60W 20/16; B60W 20/11

(52) U.S. Cl. CPC B60W 20/16; B60W 20/11; B60W 10/06

(57) ABSTRACT

A method for operating a hybrid drive train includes ascertaining an actual state vector of an internal combustion engine of the hybrid drive train; ascertaining a target power of the internal combustion engine; determining a target fuel mass flow for the internal combustion engine as a function of the target power of the internal combustion engine; determining a limit fuel mass flow of the internal combustion engine as a function of an emission limiting value, the target fuel mass flow, and the actual state vector of the internal combustion engine; determining a setpoint fuel mass flow by forming a minimum value as a function of the target fuel mass flow and the limit fuel mass flow; and setting the setpoint fuel mass flow at the internal combustion engine.

This claims the benefit of German Patent Application DE 10 2022 000 227.2, filed on Jan. 22, 2022 which is hereby incorporated by reference herein.

The present disclosure relates to a method for operating a hybrid drive train. The present disclosure relates, in particular, to a method for operating a hybrid drive train including a hydrogen-driven internal combustion engine. The present disclosure specifically relates to a method for operating a serial hybrid drive train or a hybrid drive train which may at least temporarily be operated as a serial hybrid drive train.

### BACKGROUND

Hybrid drive trains generally include two different energy converters for driving a mechanical load, for example wheels of a vehicle or hydraulic pumps. In general, the first energy converter is designed as an internal combustion engine, and the second energy converter is designed as an electric machine. As an alternative, a fuel cell may also be used, for example, instead of the internal combustion engine.

The cooperation of the two energy converters is referred to as drive train topology. In serial hybrid drive trains, the first energy converter or the internal combustion engine drives a generator, which supplies an on-board power supply system with electrical power. The second energy converter or the electrical machine, in turn, converts the electrical power of the on-board power supply system into mechanical energy, which is used for driving the mechanical load. In addition to the serial topology of hybrid drive trains, parallel and power-split topologies for hybrid drive trains are also known. The first energy converter may be operated with various fuels, for example gasoline, diesel, and hydrogen. Depending on the fuel used, the first energy converter has differing emission characteristics based on the operating state. In particular, in the case of dynamic load changes, high emission values may briefly occur.

A method is known from US 2008/236916 A1 for operating a serial hybrid drive train for a motor vehicle including an internal combustion engine. The drive train includes an output shaft, which is connected to a first electric machine in a rotatably fixed manner, a second electric machine, which is mechanically connected to a drive wheel of the vehicle, and an electrical energy store, to which electrical energy may be supplied from the first and second electric machines and which is able to supply the first and second electric machines with electrical energy. A control unit distributes electrical power between the electrical energy store and the second electric machine. The method includes the step of controlling a rotational speed of the first electric machine and the power output of the internal combustion engine.

### SUMMARY

It is an object of the present disclosure to provide a method for operating a hybrid drive train which allows a dynamic mode of operation having low emission of harmful substances.

To achieve this object, a method for operating a hybrid drive train is provided, including the steps: ascertaining an actual state vector of an internal combustion engine of the hybrid drive train; ascertaining a target power of the internal combustion engine; determining a target fuel mass flow for the internal combustion engine as a function of the target power of the internal combustion engine; determining a limit fuel mass flow of the internal combustion engine as a function of an emission limiting value, the target fuel mass flow, and the actual state vector of the internal combustion engine; determining a setpoint fuel mass flow by forming a minimum value as a function of the target fuel mass flow and limit fuel mass flow; and setting the setpoint fuel mass flow at the internal combustion engine.

The method according to the present disclosure has the advantage that the determination and the setting of the setpoint fuel mass flow may take place very quickly, so that a highly dynamic operation may be ensured, while permanently adhering to emission limiting values. In this way, for example, an exhaust after-treatment using an SCR system may be dispensed with. The typically used nitrogen oxide sensors may also be dispensed with, if allowed by the legal regulations.

Optional method steps which may be provided may thus determine a setpoint discharge of the electrical energy store as a function of the difference between the target fuel mass flow and the setpoint fuel mass flow, and setting the setpoint discharge of the electrical energy store for driving an output system of the hybrid drive train. For the determination of a setpoint discharge of the electrical energy store, initially a difference power may be determined from the difference between the target fuel mass flow and the limit fuel mass flow, which is to be provided by the electrical energy store. A desired charging power of the electrical energy store of the hybrid drive train, which was previously ascertained for the ascertainment of the target power of the internal combustion engine, may be subtracted from the difference power for the determination of the setpoint discharge.

A hybrid drive train shall, among others, be understood to mean drive trains including two different energy converters, namely an internal combustion engine and an electric machine, as well as, in particular, at least one energy store, namely a fuel tank for the internal combustion engine. Specifically, the hybrid drive train may include at least two energy stores, namely the fuel tank for the internal combustion engine and a battery.

The internal combustion engine may be designed as a hydrogen combustion engine. The internal combustion engine is then operated using an air-hydrogen mixture. The internal combustion engine may be designed as an ammonia combustion engine. The internal combustion engine is then operated using an air-ammonia mixture.

The output system of the hybrid drive train may include one or multiple output unit(s), in particular, in the form of electric motor(s).

The hybrid drive train may include a generator, which is mechanically coupled to the internal combustion engine and electrically connected via an electrical intermediate circuit of an on-board power supply system to an output system of the hybrid drive train as well as to the electrical energy store. A current transformer may be provided between the generator and the electrical intermediate circuit, which is able to convert the alternating current given off by the generator into direct current and, in particular, is designed as a bidirectional current transformer. The electrical energy store may include a DC/DC converter, which is able to convert a battery direct current to the desired direct current level of the electrical intermediate circuit. A current transformer system may be provided between the electrical intermediate circuit of the on-board power supply system and the output system, which is able to convert the direct current of the electrical intermediate circuit into an alternating current by which the output system may be driven. If the output system of the hybrid drive train includes multiple output units, a separate current transformer, which is connected to the electrical intermediate circuit and is able to convert the direct current of the electrical intermediate circuit into an alternating current, may be assigned to each output unit. The current transformer system or the separate current transformers may also, in particular, be designed as bidirectional current transformers.

The actual state vector of the internal combustion engine describes the state of the internal combustion engine at point in time T based on one or multiple vector coordinate(s). The actual state vector may encompass, as coordinates, at least one actual value of the rotational speed of the internal combustion engine, the pressure in the manifold of the injection system, the fuel mass flow, the point in time of the fuel injection during the operating cycle, and the proportion of the recirculated exhaust gas to the fresh air mass and the air mass flow.

The target power of the internal combustion engine is the power which, in the ideal case, is to be raised by the internal combustion engine at a point in time T+1 downstream from point in time T. The ascertainment of the target power of the internal combustion engine may take place as a function of a power request of the output system of the hybrid drive train and a desired charging power of the electrical energy store of the hybrid drive train. In the process, the power request of the output system may be ascertained as a function of the power demand of multiple output units of the output system. The desired charging power of the energy store may be ascertained as a function of the charge state of the energy store and/or the power request of the output system.

The target fuel mass flow is the fuel mass flow which is to be converted in the internal combustion engine into mechanical energy at a point in time T+1 downstream from point in time T, so that the internal combustion engine is able to raise the target power at point in time T+1. The determination of the target fuel mass flow may additionally take place as a function of the actual state vector of the internal combustion engine. In particular, the determination of the target fuel mass flow may additionally take place as a function of at least a partial number of the coordinates of the actual state vector of the internal combustion engine.

The emission limiting value may be a limit emission vector for the limiting values of multiple emission types. The limit emission vector may encompass one or multiple coordinate(s) in the process, which each define the limiting value of one emission type. Possible emission types are, for example, nitrogen oxides NOx, carbon dioxide CO2, or fine dust. The emission limiting value or the coordinates of the limit emission vector may be dependent on at least one of the actual state vector of an internal combustion engine, the target power of the internal combustion engine, and the target fuel mass flow for the internal combustion engine. For this purpose, for example, characteristic curves and/or characteristic maps may be read out.

The limit fuel mass flow is the fuel mass flow which may maximally be converted in the internal combustion engine into mechanical energy at a point in time T+1 downstream from point in time T, so that defined boundary conditions, for example the emission limiting values or at least a partial number of the emission limiting values of the limit emission vector, are adhered to during operation of the internal combustion engine. The determination of the limit fuel mass flow of the internal combustion engine may additionally take place as a function of a prediction emission value which is, in particular, modeled by a data model. The prediction emission value is modeled for point in time T+1 in the process.

The determination of the limit fuel mass flow of the internal combustion engine may take place with the aid of a data model, an input fuel mass flow of the data model being iteratively lowered until a prediction emission value modeled by the data model for point in time T+1 is smaller than or equal to the emission limiting value. The data model may also be referred to as emission prediction.

If the emission limiting value is designed as a limit emission vector, the determination of the limit fuel mass flow of the internal combustion engine may take place with the aid of a data model, the input fuel mass flow of the data model being iteratively lowered until the coordinates of a prediction emission vector of the data model modeled by the data model are smaller than or equal to the associated emission limiting values of the limit emission vector. The prediction emission vector encompasses the emission values modeled by the data model at point in time T+1 as coordinates.

The input fuel mass flow of the data model may initially be equated with the previously determined target fuel mass flow, both in the case of an individual emission limiting value and in the case of a limit emission vector.

The data model may additionally model an actual emission vector, which encompasses the emission values modeled by the data model at point in time T as coordinates.

The determination of the limit fuel mass flow of the internal combustion engine may, alternatively or in combination, take place with the aid of a data model which encompasses an artificial neural network. The artificial neural network may include, as neurons of an input layer, at least the actual state vector of the internal combustion engine or a partial number of the coordinates of the actual state vector, the target fuel mass flow and/or the emission limiting value or the limit emission vector. The artificial neural network may include, as neurons of an output layer, the limit fuel mass flow and/or the actual emission vector and/or the prediction emission vector.

The artificial neural network may, at a point in time TO which is chronologically before point in time T, be trained based on data of the internal combustion engine obtained from a simulation or based on measured data from test runs of the internal combustion engine. Moreover, the neural network may be trained based on a combination of data of the internal combustion engine obtained from a simulation and measured data from test runs of the internal combustion engine. This method step may also be referred to as a base calibration of the artificial neural network.

The setpoint fuel mass flow is the fuel mass flow which is actually converted in the internal combustion engine into mechanical energy at a point in time T+1 downstream from point in time T. The setpoint fuel mass flow is thus set at the internal combustion engine at a point in time T+1 downstream from point in time T.

The determination of a setpoint fuel mass flow takes place by forming a minimum value as a function of the target fuel mass flow and the limit fuel mass flow. In other words, the determination of a setpoint fuel mass flow takes place by forming a minimum value, the minimum value formation being a function of the target fuel mass flow and the limit fuel mass flow.

For the determination of the setpoint fuel mass flow by minimum value formation as a function of the target fuel mass flow and the limit fuel mass flow, the minimum value of the target fuel mass flow and of the limit fuel mass flow may be set as the setpoint fuel mass flow. For the determination of the setpoint fuel mass flow by minimum value formation as a function of the target fuel mass flow and the limit fuel mass flow, the target fuel mass flow may, alternatively, initially be converted into a target torque, and the limit fuel mass flow may be converted into a limit torque. Thereafter, the minimum value may be formed from the target torque and the limit torque, it being possible, in turn, for the resulting minimum value to be converted into a fuel mass flow, which is established as the setpoint fuel mass flow.

In principle, those skilled in the art recognize that the fuel mass flow is approximately proportional to the torque of the internal combustion engine. In this way, further method steps may be provided in the method, in which one of the target fuel mass flow, the limit fuel mass flow or the setpoint fuel mass flow is converted into a corresponding torque, and vice versa.

As an alternative or in combination, the determination of the setpoint fuel mass flow may take place as a function of an available discharge power of the electrical energy store. For this purpose, the available discharge power of the electrical energy store may be determined, in particular, as a function of the charge state of the electrical energy store.

### BRIEF SUMMARY OF THE DRAWINGS

One exemplary embodiment of the method is described hereafter based on the figures.

FIG. 1 shows a schematic view of a hybrid drive train including a serial topology; and

FIG. 2 shows the method according to the present disclosure in a flowchart.

### DETAILED DESCRIPTION

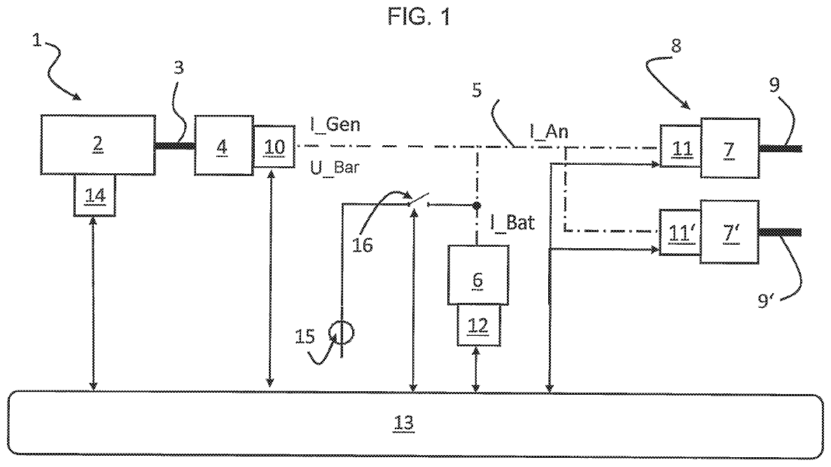

FIG. 1 shows a hybrid drive train 1 including a serial topology, which may be operated using the method according to the present disclosure. Hybrid drive train 1 includes an internal combustion engine 2, which is fixedly connected via a motor shaft 3 to a generator 4 and may rotatably drive the same. In the present example, internal combustion engine 2 is operated as a hydrogen combustion engine. Generator 4 is electrically connected via an electrical intermediate circuit of an on-board power supply system to an electrical energy store 6 and an output system 8. Electrical intermediate circuit 5 may, for example, be designed as a cable harness or a current bar. Electrical intermediate circuit 5 is switchably connected via a switch 16 to an external voltage source 15, for example to the general low-voltage power grid. Generator 4 and voltage source 15 may thus selectively or in combination apply a voltage to electrical intermediate circuit 5, so that output system 8 may be operated and/or energy store 6 may be charged.

In the present example, electrical energy store 6 is configured as a battery in the form of a Li-ion rechargeable battery. As an alternative, it is also possible to use other rechargeable batteries or also capacitors. Output system 8 includes a first output unit 7 and a second output unit 7′, which are each designed as electric motors. First output unit 7 and second output unit 7′ in each case include an output shaft 9, 9′, which is connected to a mechanical load that is not shown. In the present example, the mechanical loads are hydraulic pumps, without being limited thereto. It shall be understood that output system 8 may include an arbitrary number of output units, which may each be designed to be the same or different.

Generator 4 includes a generator control unit 10, which includes a state monitoring, with the aid of which, for example, the generator rotational speed and/or current I_Gen introduced by generator 4 into electrical intermediate circuit 5 and/or voltage U_Bar present at electrical intermediate circuit 5 may be monitored. Generator control unit 10 furthermore includes a power electronics in the form of a bidirectional AC/DC current transformer. The AC/DC current transformer may convert an AC voltage provided by generator 4 into a DC voltage, which is applied to electrical intermediate circuit 5. The power electronics of generator control unit 10 may furthermore regulate the power fed by generator 4 into electrical intermediate circuit 5.

First and second output units 7, 7′ each include an output control unit 11, 11′, which includes a state monitoring, with the aid of which, for example, the rotational speed, the output torque and/or the output power of output shafts 9, 9′ and/or voltage U_Bar present at electrical intermediate circuit 5 may be monitored. Output control units 11, 11′ each include a power electronics in the form of a bidirectional AC/DC current transformer for regulating the output torque present at output shafts 9, 9′. The AC/DC current transformer may convert a DC voltage provided by electrical intermediate circuit 5 into an AC voltage, which is applied to output units 7, 7′. Additionally, the frequency of the alternating current may be regulated via the AC/DC current transformer.

Electrical energy store 6 includes an energy store control unit 12, which includes a state monitoring, with the aid of which, for example, the charge state of energy store 6 as well as charging or discharging current I_Bat may be monitored. When energy store 6 is being charged, I_Bat has a negative sign. When energy store 6 is being discharged, I_Bat has a positive sign.

Current I_An flowing into output system 8 results from the sum of current I_Gen introduced by generator 4 into electrical intermediate circuit 5 and charging or discharging current I_Bat.

Internal combustion engine 2 includes an engine control unit 14, which includes a state monitoring, with the aid of which an actual state vector of internal combustion engine 2 may be ascertained. The actual state vector of internal combustion engine 2 describes the state of internal combustion engine 2 at a defined point in time T based on vector coordinates. In the present example, the actual state vector encompasses the actual values of the rotational speed of the internal combustion engine, the pressure in the manifold of the injection system, the fuel mass flow, the point in time of the fuel injection during the operating cycle, and the proportion of the recirculated exhaust gas to the fresh air mass and air mass flow, without being limited thereto. Engine control unit 14 may furthermore regulate the parameters necessary for the operation of internal combustion engine 2.

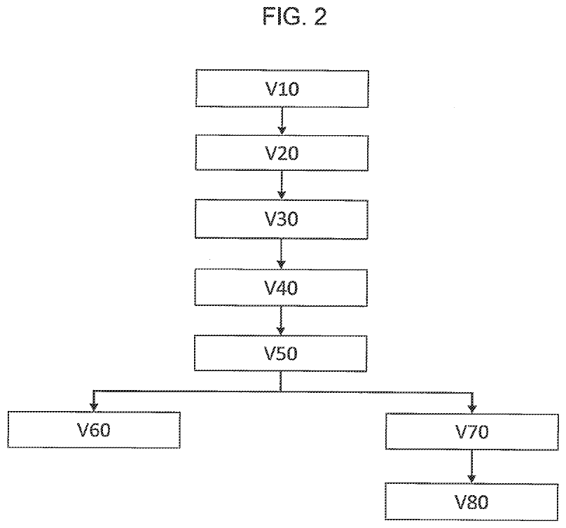

A higher-level control unit 13 is configured to communicate with generator control unit 10, output control units 11, 11′, energy store control unit 12, and engine control unit 14 and to control switch 16. Control unit 13 is configured to operate hybrid drive train 1 corresponding to the method shown in FIG. 2.

In a method step V10, control unit 13 ascertains the actual state vector of internal combustion engine 2 of hybrid drive train 1 at point in time T. For this purpose, the actual state vector is transferred from engine control unit 14 to control unit 13.

In a subsequent method step V20, control unit 13 ascertains a target power of internal combustion engine 2. The ascertainment of the target power of internal combustion engine 2 takes place as a function of a power request of output system 8 and a desired charging power of electrical energy store 6. For this purpose, the rotational speed and the output torque of output shafts 9, 9′ of output units 7, 7′ is transferred from output control units 11, 11′ to control unit 13. Control unit 13 calculates an output power for each output unit 7, 7′ from the particular rotational speed and the particular output torque. As an alternative, the output power may be ascertained in output control units 11, 11′ and be communicated directly to control unit 13. The power request of output system 8 results from the sum of the output powers of output units 7, 7′.

The desired charging power of electrical energy store 6 may be determined by energy store control unit 12 or control unit 13 as a function of the charge state of energy store 6 and/or as a function of the power requests of output system 8.

In a further method step V30, control unit 13 determines the target mass fuel flow for internal combustion engine 2 as a function of the target power of internal combustion engine 2 and as a function of the actual state vector of internal combustion engine 2. The determination of the target fuel mass flow for internal combustion engine 2 may take place via data models or characteristic maps.

In a further method step V40, control unit 13 determines the limit fuel mass flow of internal combustion engine 2. In the present case, this takes place as a function of a limit emission vector, the previously determined target fuel mass flow, and the previously ascertained actual state vector of internal combustion engine 2 with the aid of a data model. In the present example, an artificial neural network is used as the data model, which includes the limit emission vector, the target fuel mass flow, and the actual state vector of internal combustion engine 2 as neurons of an input layer. The output layer of the artificial neural network includes the limit fuel mass flow and the actual emission vector as neurons. The output layer of the artificial neural network additionally or optionally includes a prediction emission vector as a further neuron.

In a subsequent method step V50, control unit 13 determines the setpoint fuel mass flow. The setpoint fuel mass flow is equated with the smaller value of the target fuel mass flow and limit fuel mass flow.

In a further method step V60, the setpoint fuel mass flow is set at internal combustion engine 2 at point in time T+1. For this purpose, control unit 13 communicates the setpoint fuel mass flow to engine control unit 14. Engine control unit 14 controls the fuel mass flow provided by a fuel injection system corresponding to the setpoint fuel mass flow.

It shall be understood that the determination of the target fuel mass flow, the limit fuel mass flow, and the setpoint fuel mass flow for internal combustion engine 2 may, alternatively, take place in engine control unit 14, and these values may be communicated by engine control unit 14 to control unit 13.

In a further optional method step V70, a setpoint discharge of electrical energy store 6 may be determined by control unit 13 after method step V50 and, in particular, in parallel to method step V60. In the present example, this takes place as a function of the difference between the target fuel mass flow and the setpoint fuel mass flow. As an alternative or in combination, the setpoint discharge of electrical energy store 6 may also be determined as a function of the charge state of electrical energy store 6.

Thereafter, in a method step V80 which is also optional, control unit 13 sets the setpoint discharge of electrical energy store 6 for driving output system 8 of hybrid power train 1 at point in time T+1.

### LIST OF REFERENCE NUMERALS

1 hybrid drive train
2 internal combustion engine
3 engine shaft
4 generator
5 electrical intermediate circuit
6 electrical energy store
7, 7′ output unit
8 output system
9, 9′ output shaft
10 generator control unit
11, 11′ output control unit
12 energy store control unit
13 control unit
14 engine control unit
15 external voltage source
16 switch

What is claimed is:

1. A method for operating a hybrid drive train comprising:
ascertaining an actual state vector of an internal combustion engine of the hybrid drive train;
ascertaining a target power of the internal combustion engine;
determining a target fuel mass flow for the internal combustion engine as a function of the target power of the internal combustion engine;
determining a limit fuel mass flow of the internal combustion engine as a function of an emission limiting value, the target fuel mass flow, and the actual state vector of the internal combustion engine;
determining a setpoint fuel mass flow by forming a minimum value as a function of the target fuel mass flow and the limit fuel mass flow; and
setting the setpoint fuel mass flow at the internal combustion engine.

2. The method as recited in claim 1, wherein the actual state vector of the internal combustion engine encompasses at least one actual value of a rotational speed, a pressure in a manifold of an injection system, a fuel mass flow, a point in time of a fuel injection during a working cycle, and a proportion of a recirculated exhaust gas to a fresh air mass and air mass flow.

3. The method as recited in claim 1, wherein the ascertaining of the target power of the internal combustion engine takes place as a function of a power request of an output system of the hybrid drive train and a desired charging power of an electrical energy store of the hybrid drive train.

4. The method as recited in claim 3, wherein the power request of the output system is ascertained as a function of a power demand of multiple output units of the output system.

5. The method as recited in claim 3, wherein the desired charging power of the electrical energy store is ascertained as a function of a charge state of the electrical energy store.

6. The method as recited in claim 1, wherein the determining of the limit fuel mass flow of the internal combustion engine additionally takes place as a function of a prediction emission value.

7. The method as recited in claim 6, wherein the determining of the limit fuel mass flow of the internal combustion engine takes place with an aid of a data model, an input fuel mass flow of the data model being iteratively lowered until the prediction emission value of the data model is smaller than or equal to the emission limiting value.

8. The method as recited in claim 7, wherein initially the input fuel mass flow of the data model is equated with the previously determined target fuel mass flow.

9. The method as recited in claim 1, wherein the determining of the limit fuel mass flow of the internal combustion engine takes place with an aid of an artificial neural network.

10. The method as recited in claim 9, wherein the artificial neural network includes at least the actual state vector of the internal combustion engine, the target fuel mass flow, and the emission limiting value as neurons of an input layer.

11. The method as recited in claim 9, wherein the artificial neural network includes the limit fuel mass flow and/or an actual emission vector as neurons of an output layer.

12. The method as recited in claim 1, further comprising:
determining a setpoint discharge of an electrical energy store of the hybrid drive train as a function of a difference between the target fuel mass flow and the setpoint fuel mass flow; and
setting the setpoint discharge of the electrical energy store for driving an output system of the hybrid drive train.
